(19) United States
(12) Patent Application Publication
(10) Pub. No.: US 2025/0111646 A1
(43) Pub. Date: Apr. 3, 2025

(54) INFORMATION PROCESSING APPARATUS, CONTROL METHOD THEREOF, AND MEDIUM

(71) Applicant: CANON KABUSHIKI KAISHA, Tokyo (JP)

(72) Inventors: Tomoyuki TENKAWA, Chiba (JP); Masato AOBA, Tokyo (JP)

(21) Appl. No.: 18/980,100

(22) Filed: Dec. 13, 2024

Related U.S. Application Data
(63) Continuation of application No. PCT/JP2023/024200, filed on Jun. 29, 2023.

(30) Foreign Application Priority Data
Jul. 8, 2022 (JP) 2022-110587

(51) Int. Cl. G06V 10/72; G06V 10/24; G06V 10/32; G06V 10/774; G06V 10/86; G06V 10/98; G06V 40/16

(52) U.S. Cl. CPC G06V 10/72; G06V 10/245; G06V 10/32; G06V 10/774; G06V 10/86; G06V 10/98; G06V 40/165

(57) ABSTRACT

An information processing apparatus assists determination on correctness of information indicating a position and size of a verification segment of a target object in an image. The apparatus obtains a plurality of images, reference frame information indicating positions and sizes of reference frames that enclose target objects in the images, and verification frame information indicating positions and sizes of verification frames that enclose verification segments of the target objects in the images. Then, the apparatus displays a normalized reference frame at a preset position, for each of the plurality of images, and displaying, in a superimposed manner, a normalized verification frame at a relative position that is based on a normalized position and size corresponding to the normalized reference frame.

### CROSS-REFERENCE TO RELATED APPLICATIONS

This application is a Continuation of International Patent Application No. PCT/JP2023/024200, filed Jun. 29, 2023, which claims the benefit of Japanese Patent Application No. 2022-110587 filed Jul. 8, 2022, both of which are hereby incorporated by reference herein in their entirety.

### BACKGROUND OF THE INVENTION

### Field of the Invention

The present invention relates to an information processing apparatus, a control method thereof, and a program.

### Background Art

In recent years, a large number of techniques for processing a captured image and detecting an object in the image have been proposed. Among them, in particular, techniques for learning the features of an object in an image using a multi-layer neural network called “deep net” (or also referred to as “deep neural net” or “deep learning”), and recognizing the position and type of the object have been actively studied. Non-patent literature 1 discloses a technique for detecting an object in an image using deep net.

To perform training on the features of objects, ground truth information such as the positions and sizes of objects needs to be set in images by a human. Such images and ground truth information are called training data. A large amount of training data needs to be prepared to develop an accurate recognizer. Patent literature 1 describes a method for obtaining training data whose accuracy is sufficiently ensured by repeating an “operation of adding ground truth information that is performed by a human” and an “operation of evaluating the accuracy of a detector” until desired accuracy is reached.

### CITATION LIST

### Patent Literature

PTL1: Japanese Patent No. 5953151
PTL2: Japanese Patent Laid-Open No. 2019-46095

### Non-Patent Literature

NPL1: SSD: Single Shot MultiBox Detector, Wei Liu et al., 2015 NPL2: Abe Masanari, Proposal and Comparison of Threshold Setting Method in MT Method
NPL3: Jiankang Deng et al., “RetinaFace: Single-stage Dense Face Localisation in the Wild” 2 May 2019

When a user manually prepares training data, there is the possibility that ground truth information of positions and sizes will be input incorrectly due to an operational error or a misunderstanding of the definition of the training data. For this reason, with the technique in Patent literature 1, there remains a problem in that the accuracy of a recognizer will decrease when training is performed using training data that includes incorrect ground truth information.

Patent literature 2 describes a method for selecting images and ground truth information of low-reliability training data and displaying the selected images and information, thereby enabling the user to efficiently review the training data. However, the method of Patent literature 2 only improves the efficiency of a method for checking a single image, and there is an issue that checking ground truth information of a plurality of images takes time.

The present invention has been made in view of the aforementioned issue, and provides, to the user, an environment in which it is possible to efficiently determine whether or not there is an abnormality in the position and size of a verification segment of a target object in each of a plurality of images to be used as training data.

### SUMMARY OF THE INVENTION

According to one aspect of the present invention, an information processing apparatus that assists determination on correctness of information indicating a position and size of a verification segment of a target object in an image comprises:
at least one memory storing instructions; and
at least one processor that, upon execution of the stored instructions cause the at least one processor to function as:
an obtaining unit that obtains a plurality of images, reference frame information indicating positions and sizes of reference frames that enclose target objects in the images, and verification frame information indicating positions and sizes of verification frames that enclose verification segments of the target objects in the images,
a normalizing unit that normalizes a size of a reference frame indicated by the obtained reference frame information, and normalizing a size and position of a corresponding verification frame in accordance with the normalization, and
a display control unit that displays a normalized reference frame at a preset position, for each of the plurality of images, and displaying, in a superimposed manner, a normalized verification frame at a relative position that is based on a normalized position and size corresponding to the normalized reference frame.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a system configuration according to a first embodiment.

FIG. 2 is a diagram of a functional configuration of an information processing apparatus according to the first embodiment.

FIG. 3 is a flowchart showing a flow of processing that is performed by the information processing apparatus according to the first embodiment.

FIG. 4A is a diagram showing an example of images and frame information according to the first embodiment.

FIG. 4B is a diagram showing an example of a normalized reference frame and normalized verification frames.

FIG. 5 is a flowchart showing a flow of normalization processing according to the first embodiment.

FIG. 6A is a diagram showing an example of display of frame information of a normalized reference frame and normalized verification frames according to the first embodiment.

FIG. 6B is a diagram showing an example of selection of a verification frame that is based on user input.

FIG. 6C is a diagram showing an example of screen display for accepting an editing operation performed by the user.

FIG. 6D is a diagram showing an example of a verification frame corrected by the user.

FIG. 6E is a diagram showing an example of display of corrected frame information.

FIG. 7 is a diagram of a functional configuration of an information processing apparatus according to a second embodiment.

FIG. 8 is a flowchart showing a flow of processing that is performed by the information processing apparatus according to the second embodiment.

FIG. 9 is a flowchart showing a flow of statistical information calculation processing according to the second embodiment.

FIG. 10A is a diagram showing an example of display of frame information of a normalized reference frame and normalized verification frames, and statistical information according to the second embodiment.

FIG. 10B is a diagram showing an example of selection of statistical information that is based on user input.

FIG. 10C is a diagram showing an example of display of frame information when statistical information is selected.

FIG. 11 is a diagram of a functional configuration of an information processing apparatus according to a third embodiment.

FIG. 12 is a flowchart showing a flow of statistical information calculation processing according to the third embodiment.

FIG. 13 is a diagram of a functional configuration of an information processing apparatus according to a fourth embodiment.

FIG. 14 is a diagram showing an example of information held in a frame information holding unit according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

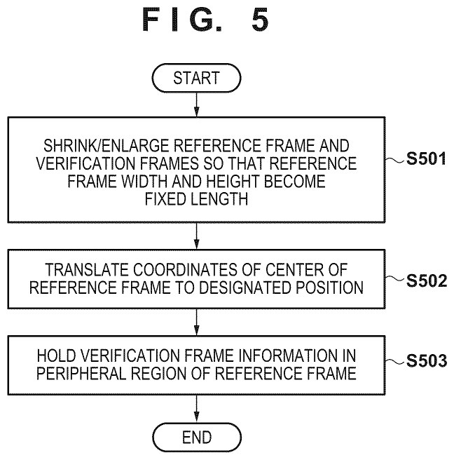

In the present embodiment, as an example, a description will be given on a tool for assisting verification and correction of a frame, which is ground truth information of the pupils of a person and was input in advance, in an image showing the face of the person. By defining a frame of the head portion of the person that is corelated to the pupils in terms of position or size as a frame of reference (hereinafter, a “reference frame”), and comparing the relative position and size of the reference frame with those of frames of the pupils to be verified (hereinafter, “verification frames”), the validation of the verification frames is verified. The correspondence relationship between an input image, a reference frame, and verification frames will be described later with reference to FIGS. 4A and 4B. In the present embodiment, an example will be illustrated in which there is a correlation in position and size, but it is sufficient that there is a correlation in one of position and size. In addition, coordinate points indicating only the position of an object for which there is no size information may be set, or size information of an object that randomly appears in the image, and has no correlation in position may be compared. In addition, a verification segment is a pupil for convenience, but may be a part of a face other than a pupil.

### <System Configuration>

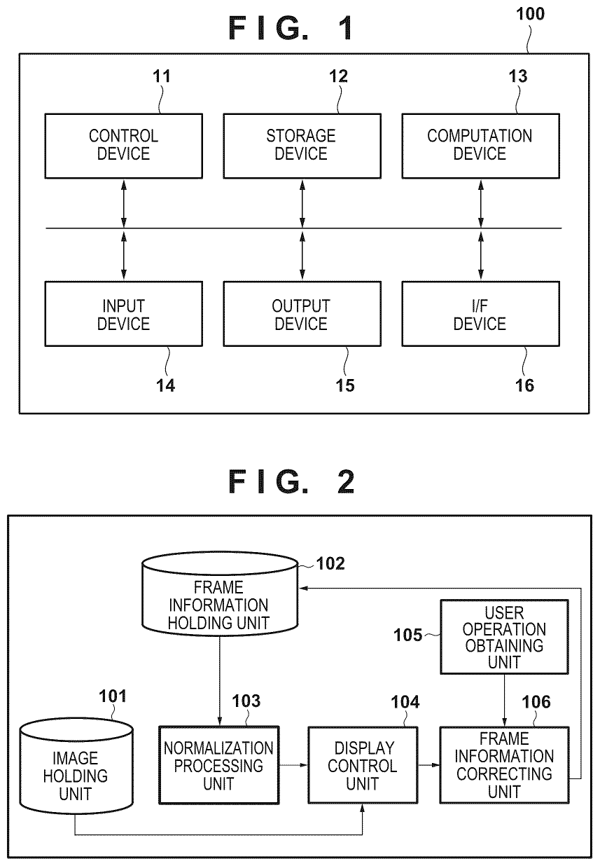

FIG. 1 shows an exemplary system configuration of an information processing apparatus 100 according to the present embodiment. The information processing apparatus 100 includes, as a system configuration thereof, a control device 11, a storage device 12, a computation device 13, an input device 14, an output device 15, and an I/F device 16.

The control device 11 performs overall control of the information processing apparatus 100, and is constituted by a CPU and a memory that stores a program that is executed by the CPU.

The storage device 12 holds a program and data required for operations of the control device 11, and is typically a hard disk drive or the like.

The computation device 13 executes required computation processing under control of the control device 11.

The input device 14 is a human interface device or the like, and transmits a user operation to the information processing apparatus 100. The input device 14 is constituted by an input device group that includes a switch, buttons, keys, a touch panel, a keyboard, and the like.

The output device 15 is a display or the like, and presents, to the user, a processing result and the like of the information processing apparatus 100.

The I/F device 16 is a wired interface such as a universal serial bus, Ethernet, or an optical cable, or a wireless interface such as Wi-Fi or Bluetooth. An image capture apparatus such as a camera can be connected to the I/F device 16. Also, the I/F device 16 functions as an interface for taking an image captured by the image capture apparatus into the information processing apparatus 100. In addition, the I/F device 16 also functions as an interface for transmitting a processing result obtained by the information processing apparatus 100, to the outside. Furthermore, the I/F device 16 also functions as an interface for inputting a program, data, and the like required for operations of the information processing apparatus 100, to the information processing apparatus 100.

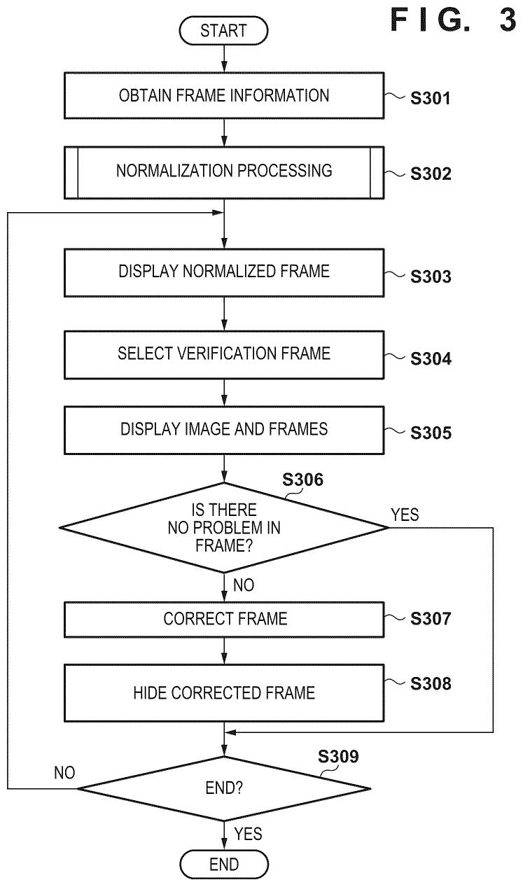

FIG. 2 is a diagram showing a functional configuration of the information processing apparatus 100. The information processing apparatus 100 includes an image holding unit 101, a frame information holding unit 102, a normalization processing unit 103, a display control unit 104, a user operation obtaining unit 105, and a frame information correcting unit 106.

Note that the control device 11 shown in FIG. 1 loads a program stored in the storage device 12 to a memory, and executes the program. It should be understood that the functional units that constitute the functional configuration in FIG. 2 function by the control device 11 executing a program.

The image holding unit 101 holds a plurality of images. Images that are held therein may be images captured by a camera or the like, images recorded in a storage device such as a hard disk, or images received via a network such as the Internet. The image holding unit 101 is realized by the storage device 12, for example.

The frame information holding unit 102 holds a table for managing frame information that was input in advance in association with images held in the image holding unit 101. The frame information according to the present embodiment is information regarding the presence of a target object (person) in each image, and information indicating the position and size of a reference frame (typically, a circumscribed rectangular frame) that encloses a target segment (face) in the image, and the positions and sizes of frames that enclose parts of the face (in the embodiment, eyes). A position is expressed as the values of two-dimensional coordinates of the upper-left corner of a frame. A size is expressed as values representing the length in the horizontal direction and the length in the perpendicular direction of a frame. In addition, this frame information holding unit 102 is realized by the storage device 12, for example.

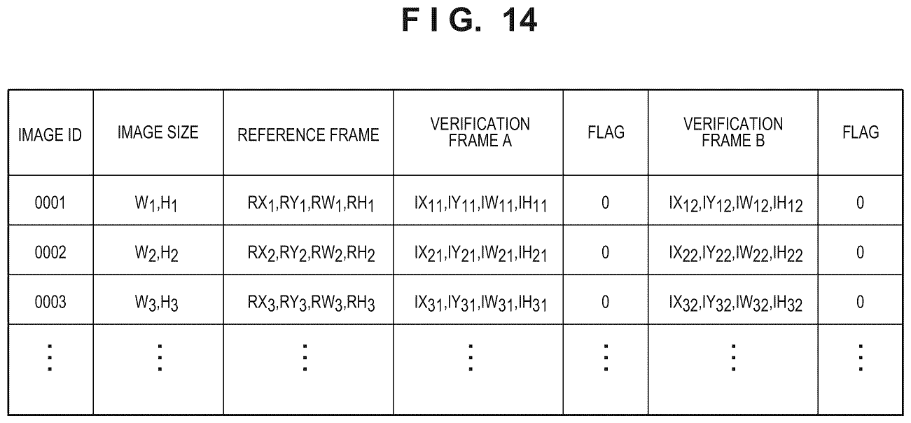

FIG. 14 shows an example of a table held in the frame information holding unit 102. The first field of the table includes IDs for specifying image files. When an image file is specified, an image file name may be used. The second field includes sizes (the numbers of pixels in the horizontal and perpendicular directions) of images indicated by the image files. The third field includes the positions and sizes of reference frames that enclose a face region of a person in the images. The position of the upper left corner of an image is defined as an origin (0,0), the horizontal rightward direction from the origin is defined as the positive direction of the x axis, and the perpendicular downward direction is defined as the positive direction of the y axis. The position of a reference frame refers to the position of the upper left corner of the reference frame, and the size of a reference frame refers to the lengths (the numbers of pixels) in the horizontal and perpendicular directions of the reference frame.

The fourth field of the table includes the positions and sizes of rectangular frames that each include a verification frame A (for example, the right eye of a person). The definitions of position and size have already been given in the description of a verification frame. The fifth field represents a correctness check flag for the verification frame A in the fourth field, and stores ‘0’ indicating “unchecked” at the initial stage.

The sixth field includes the positions and sizes of rectangular frames that each include a verification frame B (for example, the left eye of the person). The seventh field represents a correctness check flag for the verification frame B in the sixth field, and stores ‘0’ indicating “unchecked” at the initial stage.

The normalization processing unit 103 performs normalization processing on a plurality of frames obtained by the frame information holding unit 102. Here, normalization processing refers to conversion processing of two-dimensional coordinates of a frame. Examples of such processing include conversion processing that is performed such that a certain reference frame is positioned at a fixed position in the two-dimensional coordinate system of the image, and has a fixed size. A verification frame is also converted similarly in accordance with the normalized reference frame. A purpose of normalization processing is to make it easy to grasp the relative positions and relative sizes between a reference frame and verification frames of each image.

The display control unit 104 displays, on the output device 15, a reference frame subjected to normalization performed by the normalization processing unit 103 (hereinafter, a “normalized reference frame”) and verification frames subjected to normalization performed by the normalization processing unit 103 (hereinafter, “normalized verification frames”), and an image held in the image holding unit 101.

The user operation obtaining unit 105 obtains user operation information input through the input device 14.

The frame information correcting unit 106 corrects frame information in accordance with a user operation obtained by the user operation obtaining unit 105, and stores the corrected frame information in the frame information holding unit 102.

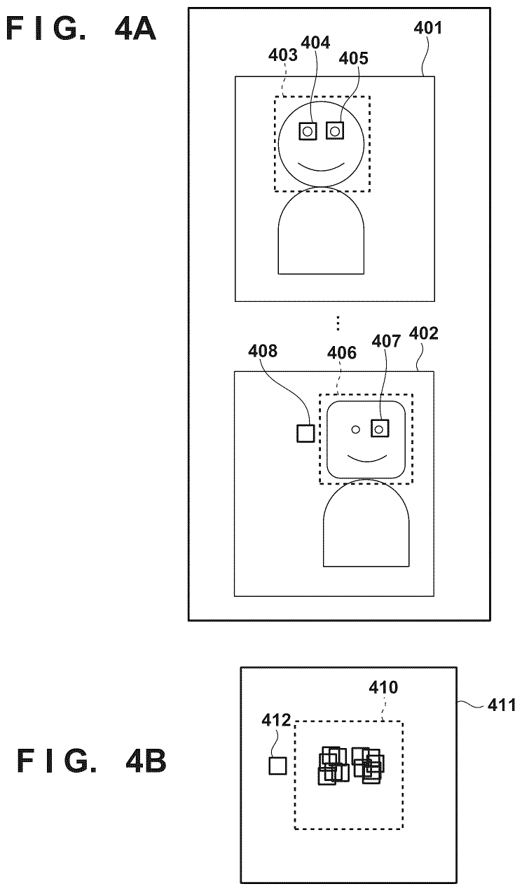

Next, an example of a flow of processing that is performed by the information processing apparatus 100 according to the present embodiment will be described with reference to FIG. 3.

In S301, the control device 11 refers to a table held in the frame information holding unit 102, and obtains frame information of reference frames and verification frames.

FIG. 4A is a diagram showing an example of images and frame information. In FIG. 4A, reference numeral 401 denotes an image that encloses a target object (person), reference numeral 403 denotes a reference frame corresponding to a target segment (head) of the target object, and reference numerals 404 and 405 denote verification frames (in the embodiment, eyes). In addition, FIG. 4A also shows an image 402 of another person. This image 402 also includes a reference frame 406 and verification frames 407 and 408. Note that, for simplification, the images 401 and 402 each show one person.

In S301, the control device 11 references the table (FIG. 14) held in the frame information holding unit 102, and obtains frame information of the reference frames (reference numerals 403 and 406 in FIG. 4A, for example) and verification frames (reference numerals 404, 405, 407, and 408, for example) of the images.

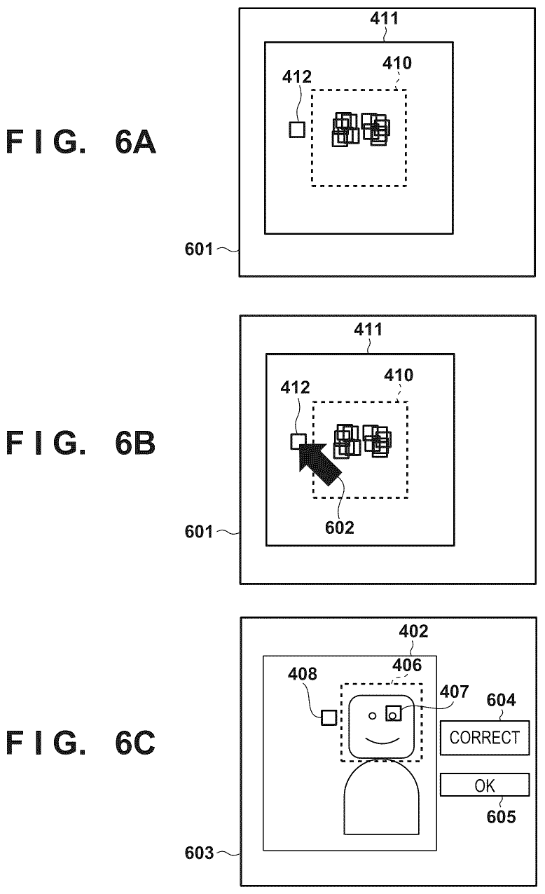

In S302, the normalization processing unit 103 performs normalization processing on the obtained reference frames and verification frames. FIG. 5 shows a flow of normalization processing, which will be described. Here, the reference frame 403 in FIG. 4A will be described as an example.

In S501, the normalization processing unit 103 scales (shrinks or enlarges) the reference frame and verification frames such that the width and height of the reference frame 403 reach a fixed size. In a case where, for example, both the number of pixels in the horizontal direction and the number of pixels in the perpendicular direction of a target fixed size are 500 pixels, and the size in the horizontal direction and the size in the perpendicular direction of the reference frame 403 are respectively 400 pixels and 300 pixels, the normalization processing unit 103 sets the scaling factor in the horizontal direction to 1.25 (=500/400), and sets the scaling factor in the perpendicular direction to 1.67 (=500/300). The normalization processing unit 103 then changes the position and size of the reference frame in accordance with the determined scaling factors in the perpendicular and horizontal directions. In a case where, for example, the reference frame of an image ID=0001 in FIG. 14 is the above reference frame 403, the normalization processing unit 103 scales RX1 and RW that have horizontal components by a factor of 1.25, and scales RY1 and RH1 that have perpendicular components by a factor of 1.67. In addition, the normalization processing unit 103 also changes the positions and sizes of the verification frames A and B in accordance with the determined scaling factors in the perpendicular and horizontal direction.

In S502, the normalization processing unit 103 translates the central coordinates of the normalized reference frame to a designated position. In a case where the designated position is (x, y)=(500 pixels, 500 pixels), and the central coordinates of the reference frame 403 are (x, y)=(300 pixels, 200 pixels), for example, the reference frame 403 is translated by +200 pixels in the x direction and by +300 pixels in the y direction. Similarly, the coordinates of the verification frames 404 and 405 are translated.

In S503, the normalization processing unit 103 holds verification frame information that is in a peripheral region of the reference frame 403. Verification frame information for x-coordinates and y-coordinates on the coordinate system that are included in a range of 0 to 1000 pixels is held in the storage device 12, for example.

The normalization processing unit 103 repeatedly performs processing of these steps S501 to S503 on all of the reference frames obtained in S301. In this manner, normalized reference frame information that is frame information of a plurality of reference frames subjected to normalization (hereinafter, “normalized reference frames”), and normalized verification frame information that is frame information of verification frames subjected to normalization (hereinafter, “normalized verification frames”) are obtained.

Next, a display example of a normalized reference frame and normalized verification frames will be described with reference to FIG. 4B. In FIG. 4B, reference numeral 410 denotes a normalized reference frame. Even though the sizes of individual images and reference frames vary, normalized reference frames have consistent sizes, and no deviation occurs. A frame denoted by reference numeral 412 and a plurality of solid-line frames that are in the normalized reference frame 410 are normalized verification frames. In addition, reference numeral 411 denotes a frame representing a peripheral region calculated in S503. The positions of a head portion and pupils are correlated, and thus it can be seen that the normalized verification frame 412 corresponding to a verification frame 408 that does not correctly represent the position of the pupil is at a position that significantly deviates relative to other verification frames. In this manner, by superimposing and displaying normalized reference frames and normalized verification frames of a plurality of images, it is possible to check a plurality of frames at the same time, and identify an unnatural frame.

Returning to the description with reference to FIG. 3, in S303, the display control unit 104 performs control for displaying, on the output device 15, frame information of the normalized reference frames and the normalized verification frames calculated in S302, and the statistical information calculated in S303.

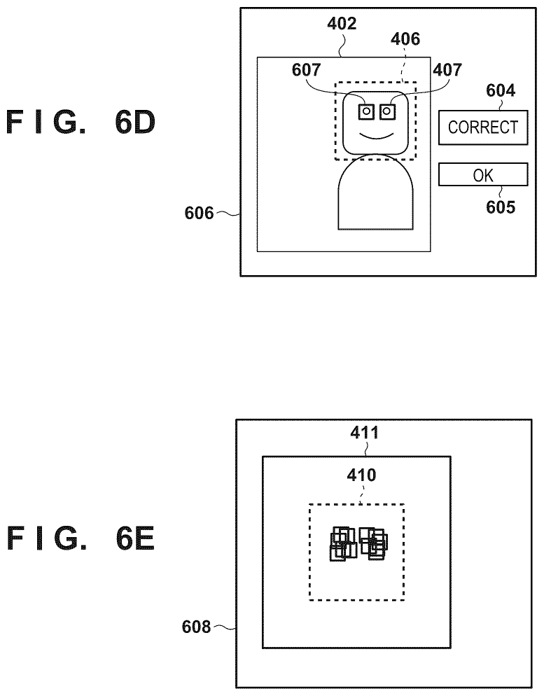

A display example and a display transition example of frame information of a normalized reference frame and normalized verification frames will be described with reference to FIGS. 6A to 6E. Reference numeral 601 in FIG. 6A denotes a window displayed on the output device 15. Reference numeral 411 in the window 601 denotes a frame that represents a peripheral region of the normalized reference frame illustrated in FIG. 4B. In the peripheral region 411, a plurality of normalized verification frames corresponding to the normalized reference frame are displayed in a superimposed manner.

In S304, the user operation obtaining unit 105 selects a verification frame in accordance with input from the user. Here, the user input is given through an operation performed a pointing device such as a mouse, and selection of a verification frame is accepted. In FIG. 6B, reference numeral 602 denotes a mouse cursor, and the user can select a target verification frame by performing an operation of changing the position of this mouse cursor. In the case of the embodiment, in the window 601, the normalized verification frame 412 that is unnaturally separate from other verifications frames is selected by the user. Note that, in a case of using touch input, the user only needs to touch the normalized verification frame 412, and thus a mouse cursor does not need to be displayed.

In S305, in accordance with the verification frame information selected in S305, the display control unit 104 transitions the screen from the window 601 in FIG. 6B to a user-editable window 603 in FIG. 6C. At this time, the display control unit 104 references the table in FIG. 14, and displays the image 402, the reference frame 406, and the verification frames 407 and 408 associated with the verification frame 412 selected in S305. In addition, the display control unit 104 arranges and displays a correct button 604 for accepting frame information correction and an OK button 605 for returning to the window 601, on the window 603.

If it is determined in S306 that the OK button 605 has been pressed, the display control unit 104 determines that the frame has no problem, and skips S307. In addition, in order to hide, in S309 to be described later, a normalized verification frame for which the OK button has been pressed, the display control unit 104 stores flag information indicating a “correct frame” as correctness information of the frame, in the frame information holding unit 102. The display control unit 104 stores “1” as a flag for the verification frame in the table in FIG. 14, for example.

On the other hand, if it is determined in S306 that the correct button 604 has been pressed, the display control unit 104 determines that there is a problem with the frame, and advances the procedure to S307. In this S307, in order to correct the frame, the display control unit 104 transitions the screen to a window 606 in FIG. 6D to enable the user to correct the frame information. A configuration is adopted in which, for example, the position of the verification frame 408 can be corrected by performing a move operation (drag operation) while continuously pressing a central portion of the verification frame 408, and the frame size can be corrected by continuously pressing the frame line of the verification frame 408. Processing opposite to normalization is performed on the corrected position and size of the normalized verification frame so as to convert the position and size into a position and size that are based on the scale of the original image, and the table is then corrected.

FIG. 6D indicates that the verification frame 408 has been corrected to a verification frame 607, on the window 606, as an example of a corrected frame. The frame information of the corrected position and size of the verification frame 607 is stored again in the frame information holding unit 102 by the frame information correcting unit 106 (the table in FIG. 14 is updated).

In S308, when pressing of the OK button 605 is detected after correction, the display control unit 104 transitions the screen to a window 608 in FIG. 6E. In addition, in order to hide, in S309 to be described later, the normalized verification frame for which the OK button has been pressed, a flag indicating a “correct frame” is set to “1”, which is stored as the correctness information of the frame. The display control unit 104 hides the verification frame for which the flag is set to “1”. As a result, other normalized verification frames that have not been checked become easier to view.

Next, in S309, the display control unit 104 waits for the user to input an instruction to or not to end the processing. When a button (not illustrated) for instructing that a series of correction operations be ended is pressed, or correction operations for all of the frames were complete, the display control unit 104 ends the processing. Note that, when the processing is ended, a verification frame for which the flag remains at the initial value “0” is determined as being correct. When the processing is ended in S309, the display control unit 104 closes the window 608. When the processing is not ended in S309, the display control unit 104 continues to display the window 608 such that the user can check and correct the verification frame. In addition, in the case where the flag information is 1 in S306 and S308, the display control unit 104 hides the corresponding normalized verification frame 412.

Note that, in the present embodiment, an example has been described in which a rectangular frame is displayed as a verification frame, but, for example, a polygonal or circular region frame may be set. In addition, coordinate points that indicate only the position of an object for which there is no size information may be set, and it is also possible to compare the size information of objects that randomly appear on the image, and have no correlation in position. Furthermore, the present invention may be applied to pixel-level label information. In addition, this aspect has been illustrated using a frame of a head portion and a frame of a face, but a frame of a whole body and a frame of a head portion may be used, or relation between a frame of a whole body and any suitable object held by the person may be used.

Furthermore, in the above description, a person is used as an example, but the present invention is also applicable to a general object, and, for example, when a frame circumscribing the entire region of a person on a motorcycle is envisioned, it is also possible to separate a frame that correctly encloses both the motorcycle and the person from a frame that incorrectly encloses only the motorcycle.

As described above, the information processing apparatus according to the present embodiment enables the user to efficiently review training data suspected to be incorrect, by displaying the relative position of a verification frame (pupil) and a reference frame (head) that is correlated to the verification frame in terms of position and size, at the same time.

### Second Embodiment

In a second embodiment, a configuration of selection and correction of a normalized verification frame that uses the distribution of statistical information will be described. Description of the same portions as those of the first embodiment is omitted, and only differences will be described.

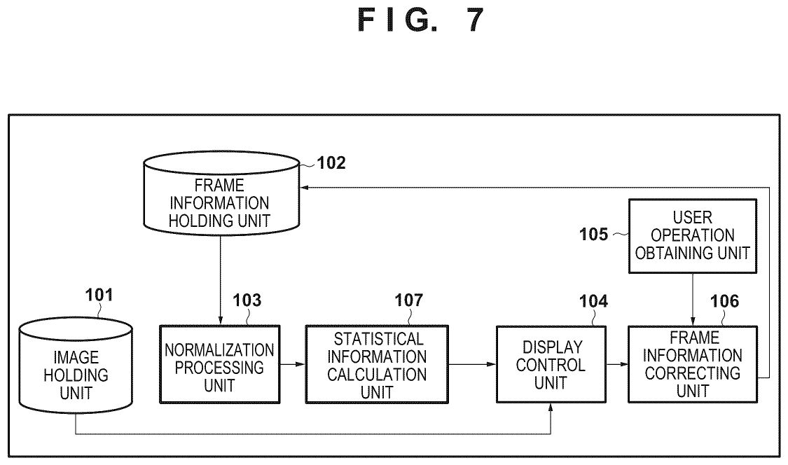

FIG. 7 is a diagram of a functional configuration of the information processing apparatus 100 according to the second embodiment. A difference from FIG. 2 of the first embodiment is that a statistical information calculation unit 107 is added.

The statistical information calculation unit 107 calculates a relative distance, relative size, and relative angle of a verification frame normalized by the normalization processing unit 103. In addition, the statistical information calculation unit 107 creates graphs such as a histogram and a scatter diagram based on the calculated relative distance, relative size, relative angle.

The display control unit 104 displays statistical information calculated by the statistical information calculation unit 107 on the output device 15.

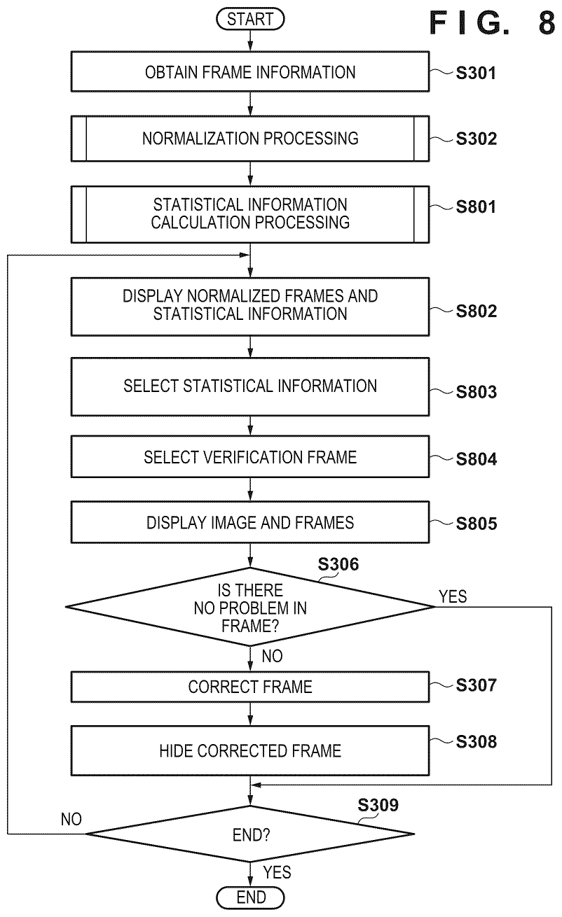

An example of a flow of processing that is performed by the information processing apparatus 100 according to the second embodiment will be described below with reference to the flowchart in FIG. 8.

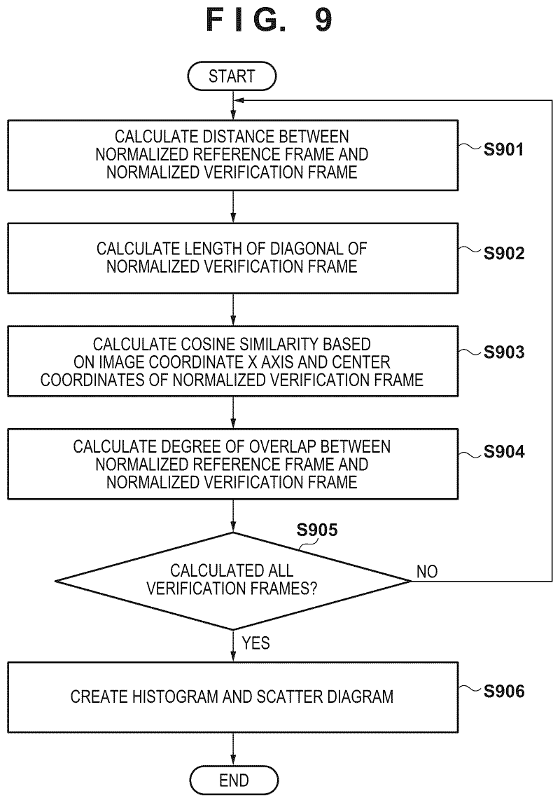

In S801, the statistical information calculation unit 107 calculates statistical information of a normalized verification frame. This statistical information calculation processing will be described in detail with reference to the flowchart in FIG. 9.

In S901, the statistical information calculation unit 107 calculates the distance between the central coordinates of a normalized reference frame and the central coordinates of a normalized verification frame. The Euclidean distance is used as the distance, for example.

In S902, the statistical information calculation unit 107 calculates the size of the normalized verification frame. The length of a diagonal of the normalized verification frame is used as the size, for example.

In S903, the statistical information calculation unit 107 calculates the angle of the normalized verification frame. As calculation of the angle, the statistical information calculation unit 107 calculates the angle of the straight line between the central coordinates of the normalized reference frame and the central coordinates of the normalized verification frame relative to the image coordinate x axis, and calculates the cosine similarity based on the angle, for example.

In S904, the statistical information calculation unit 107 calculates the degree of overlap between the normalized reference frame and the normalized verification frame. The statistical information calculation unit 107 calculates, as the degree of overlap, for example, the ratio (IoU: intersection over union) of the area of the intersection (overlapping region) of two regions of interest to the area of the union of sets of the two regions.

In S905, the statistical information calculation unit 107 determines whether or not the processing of S901 to S904 has been performed on all of the verification frames,

If it is determined in S905 that there is still a verification frame that remains to be processed, the statistical information calculation unit 107 returns the procedure to S901, and performs processing on the next verification frame.

On the other hand, if it is determined in S905 that the statistical information calculation unit 107 has performed the processing on all of the verification frames, the procedure advances to S906. In this step S906, the statistical information calculation unit 107 creates a histogram and scatter diagram based on the calculated relative distance, relative size, and relative angle. The histogram is a histogram of the frequency of a verification frame when the relative distance, relative size, or relative angle is set as a horizontal axis, and is created for the purpose of checking verification frame information that deviates from distribution of one variable. In addition, the scatter diagram is a scatter diagram of relative distance and relative size, a scatter diagram of relative distance and relative angle, or a scatter diagram of relative size and relative angle, and is created for the purpose of checking frame information that deviates from distribution of two variables. Distribution of two variables may be expressed as heatmap display in place of a scatter diagram.

Returning to the description of FIG. 8, in S802, the display control unit 104 performs control for displaying, on the output device 15, frame information of the normalized reference frame and normalized verification frames calculated in S302, and the statistical information calculated in S801.

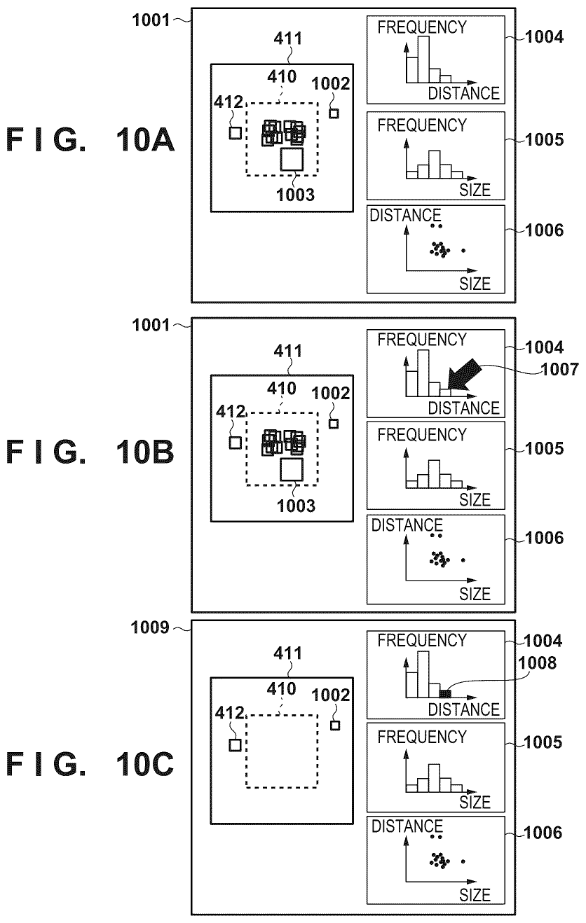

FIGS. 10A to 10C show frame information of a normalized reference frame and normalized verification frames, a display example of statistical information, and a selection example of statistical information. Reference numeral 1001 in FIG. 10A denotes a window that is displayed on the output device 15. In the window 1001, reference numeral 410 denotes a normalized reference frame. Frames denoted by reference numerals 412, 1002, and 1003, and solid-line frames in the normalized reference frame 410 are normalized verification frames. Histograms and a scatter diagram of the statistical information calculated in S801 are displayed as indicated by reference numerals 1004, 1005, and 1006. The histogram 1004 represents a histogram of distance, and the histogram 1005 represents a histogram of size. In addition, the scatter diagram 1006 is a scatter diagram of size and distance. Here, no histogram or scatter diagram of angle or the degree of overlap is illustrated, but a histogram or a scatter diagram of angle or the degree of overlap may be displayed by pressing a button (not illustrated). In addition, a configuration may also be adopted in which a histogram and a scatter diagram of information the user desires to display can be selected from a pulldown menu (not illustrated).

In S803, the display control unit 104 selects a class or a range for the distribution of the statistical information in accordance with user input from the user operation obtaining unit 105. By causing the user to select a class or a range for the distribution of the statistical information, and limiting the number of verification frames that are displayed, normalized verification frames can be easily checked. In FIG. 10B, reference numerals 1007 denotes a mouse cursor that responds to a mouse operation. In the illustrated case, the mouse cursor 1007 is selecting a graph element representing the largest class in the histogram of distance. The display control unit 104 transitions the screen from the window 1001 in FIG. 10B to a window 1009 in FIG. 10C in accordance with the selection. The display control unit 104 fills in the class selected by the user on the window 1001 such that it is possible to check which class has been selected. In addition, even when a large number of verification frames are being displayed, the display control unit 104 can limit verification frames to be checked by displaying, in the peripheral region 411, only the normalized verification frames 412 and 1004 corresponding to the filled class.

Here, an example has been described in which a class in a histogram of distance is selected, but it is also possible to display only a normalized verification frame 1003 that is larger than the other frames, by selecting the largest class in the histogram 1005 of size.

In addition, in the second embodiment, an example has been described in which a normalized verification frame is displayed by selecting a class in statistical information, but, for example, a configuration may also be adopted in which the screen transitions to the window 603 in FIG. 6C, and the user is prompted to check the image and the verification frames.

Furthermore, a configuration may also be adopted in which a range in the scatter diagram 1006 is selected by drawing a circle (not illustrated) by performing a mouse operation or the like, and thereby only the normalization display frames included in the circle are displayed. In addition, a configuration may also be adopted in which the area of the normalized verification frames that are in the peripheral region 411 in the window 1001 is designated by drawing a circle (not illustrated) or the like, and thereby only the normalized verification frames included in the circle are displayed. In addition, a configuration may also be adopted in which, in this state, it is possible to proceed to edition processing similarly to the first embodiment.

As described above, in the second embodiment, distribution of statistical information of verification frames is visualized, and a class of distribution or a group of normalized verification frames is selected and displayed. Due to such display, the user can visually recognize only a verification frame suspected to be incorrect, making an operation of checking verification frames easy.

### Third Embodiment

In a third embodiment, a configuration will be described in which a normalized verification frame suspected to be incorrect is automatically selected using statistical information. A description of the same portions as those in the second embodiment is omitted, and only differences will be described.

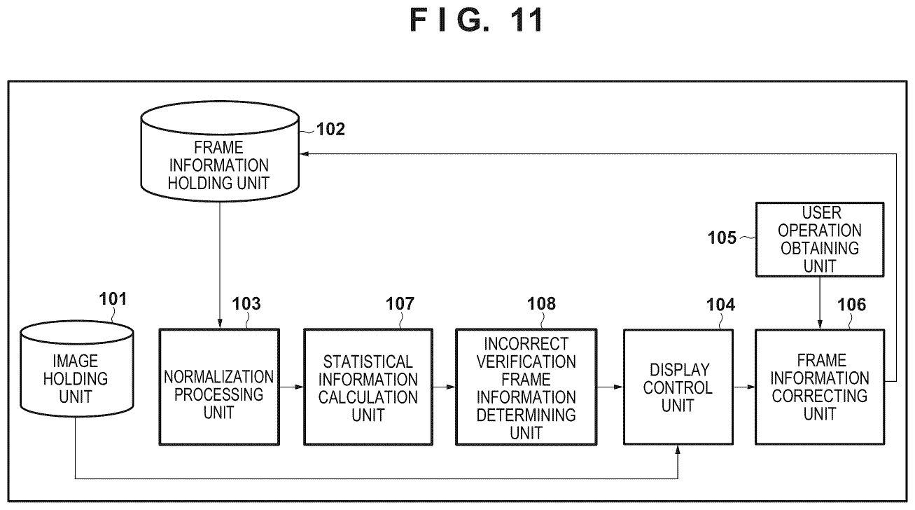

FIG. 11 is a diagram of a functional configuration of the information processing apparatus 100 according to the third embodiment. The difference from FIG. 7 in the second embodiment is that an incorrect verification frame information determining unit 108 is added.

The incorrect verification frame information determining unit 108 performs determination on a frame that is highly likely to be incorrect, based on statistical information. Assuming that, as statistical information, one normalized verification frame includes four vector components, namely relative distance, relative size, relative angle, and the degree of overlap, a Mahalanobis distance described in Non-patent literature 2 is calculated, and, if the Mahalanobis distance exceeds a preset threshold, it is determined that the normalized verification frame is highly likely to be incorrect.

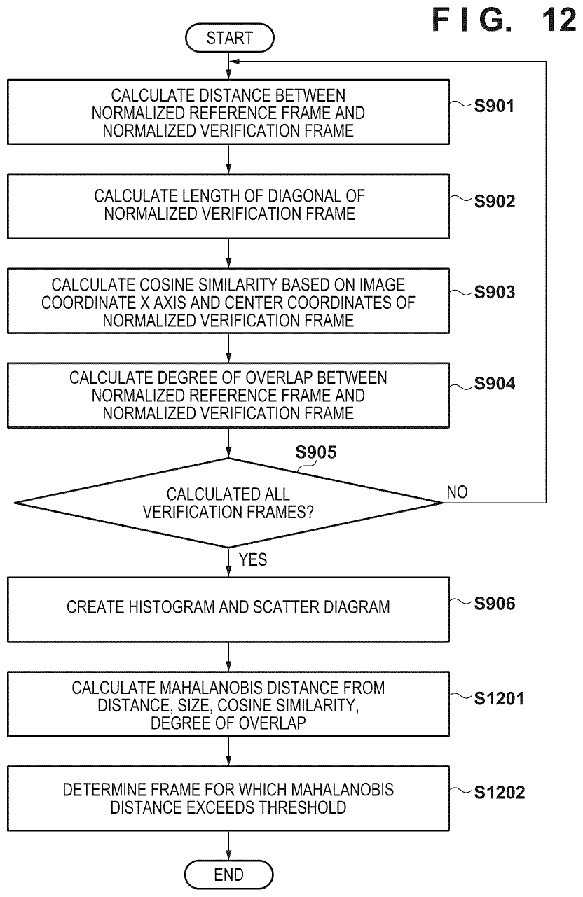

FIG. 12 shows a flow of statistical information calculation processing according to the third embodiment. Only portions that are different from those of the flow of statistical information calculation processing in FIG. 9 according to the second embodiment will be described.

In S905, the statistical information calculation unit 107 determines whether or not processing of S901 to S904 has been performed on all of the verification frames. If it is determined in S905 that the processing on all of the verification frames has been ended, the statistical information calculation unit 107 performs processing of S906, and in S1201, calculates the Mahalanobis distance of distance, size, angle, and the degree of overlap for each verification frame.

Then, in S1202, the statistical information calculation unit 107 determines whether or not there is a normalized verification frame for which the Mahalanobis distance exceeds a threshold. The threshold that is stipulated here is set to 1, for example. Next, in S802, the display control unit 104 displays only a normalized verification frame for which the Mahalanobis distance exceeds the threshold.

Note that, in the present embodiment, an example has been described in which the threshold is set in advance, but a configuration may also be adopted in which the threshold can be suitably changed by the user using an input form (not illustrated). In addition, a configuration may also be adopted in which a plurality of thresholds in place of a single threshold are set, and a switch is made using a button (not illustrated) for displaying a normalized verification frame for each of the regions segmented by a plurality of thresholds.

In addition, a normalized verification frame for which the Mahalanobis distance does not exceed the threshold may be made easy to view, using different colors instead of hiding such a normalized verification frame, or information for performing determination may be given to the user by displaying the Mahalanobis distance near the frame.

Note that, in the present embodiment, normalized verification frames are limited using the Mahalanobis distances, but, for example, a configuration may also be adopted in which values that deviate from the center, namely the average value by three times the standard deviation or more are defined as outliers, and are regarded as candidates for incorrect verification frame. In addition, a configuration may also be adopted in which, using a median and quartiles, values that deviate from the first quartile value by quartile difference are defined as outliers, and regarded as candidates for incorrect verification frame.

As described above, according to the third embodiment, based on statistical information of verification frames, an outlier of the statistical information of the verification frame information is determined through threshold processing. Accordingly, a verification frame suspected to be incorrect can be proposed to the user, making the operation of checking the verification frames easy.

### Fourth Embodiment

In a fourth embodiment, a configuration will be described in which, instead of preparing a reference frame in advance, normalization processing is performed using a frame detected by an object frame detection unit, and verification frames are selected. A description of the same portions as those in the third embodiment is omitted, and only differences will be described.

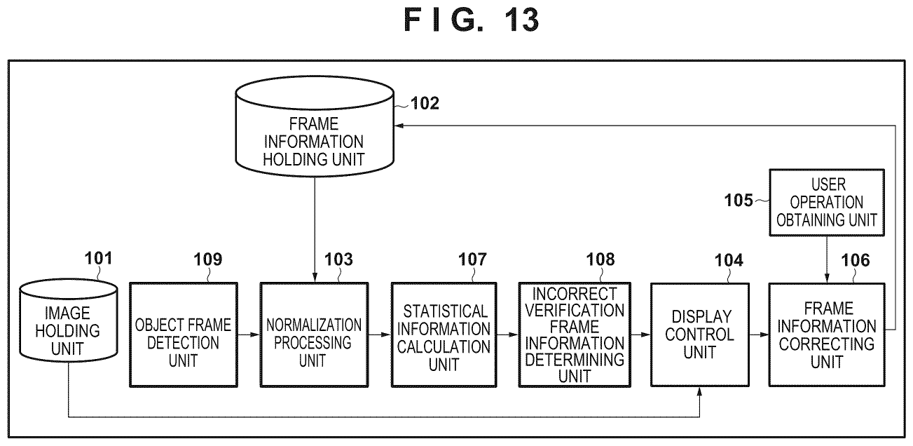

FIG. 13 is a diagram of a functional configuration of the information processing apparatus 100 according to the fourth embodiment. A difference is that an object frame detection unit 109 is provided in addition to the configuration in the third embodiment.

When a pair of an image and a verification frame is input, this object frame detection unit 109 detects a reference frame in the image, for example, using a hierarchical convolutional neural network such as those illustrated in Non-patent literatures 1 and 3. Accordingly, without preparing a reference frame in advance, it is possible to verify a verification frame with respect to the reference frame, and reduce the effort required for inputting a reference frame.

Note that, as a method for verifying a detection frame that is performed by the object frame detection unit 109, a configuration may be adopted in which normalization processing is performed on a reference frame prepared in advance and verification frames detected by the object frame detection unit, and a verification frame is selected.

The first to fourth embodiments have been described above. In the above embodiments, the eyes of a person are shown in verification frames, which is an example in which one reference frame is used for two verification frames, but it should be noted that, in particular, it suffices for the number of verification frames to be one or more, and the number of frames is not particularly limited.

According to the present invention, it is possible to provide, to the user, an environment in which it is possible to efficiently determine whether or not there is an abnormality in the position and size of a verification segment of a target object in each of a plurality of images to be used as training data.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus that assists determination on correctness of information indicating a position and size of a verification segment of a target object in an image, comprising:
at least one memory storing instructions; and
at least one processor that, upon execution of the stored instructions cause the at least one processor to function as:
an obtaining unit that obtains a plurality of images, reference frame information indicating positions and sizes of reference frames that enclose target objects in the images, and verification frame information indicating positions and sizes of verification frames that enclose verification segments of the target objects in the images;
a normalizing unit that normalizes a size of a reference frame indicated by the obtained reference frame information, and normalizing a size and position of a corresponding verification frame in accordance with the normalization; and
a display control unit that displays a normalized reference frame at a preset position, for each of the plurality of images, and displaying, in a superimposed manner, a normalized verification frame at a relative position that is based on a normalized position and size corresponding to the normalized reference frame.

2. The information processing apparatus according to claim 1, wherein the instructions further cause the at least one processor to function as:
a selecting unit that selects the displayed verification frame; and
an editing unit that corrects a size and a position of the selected verification frame,
wherein the display control unit hides the verification frame edited by the editing unit.

3. The information processing apparatus according to claim 2, wherein the plurality of images, reference frame information of the images, and verification frame information edited by the editing unit are used as training data.

4. The information processing apparatus according to claim 1, wherein the reference frame is a frame that encloses a face of a person in an image, and the verification frame is at least one frame that encloses segments that constitute the face.

5. The information processing apparatus according to claim 2, wherein the instructions further cause the at least one processor to function as:
a calculating unit that calculates at least one piece of statistical information that indicates relative deviation in position and size of each verification frame, based on the reference frame information normalized by the normalizing unit, and the verification frame information,
wherein the display control unit
displays the statistical information calculated by the calculating unit as a graph, and
in a case where an element of the displayed graph is selected by the selecting unit, displays only the verification frame that belongs to the element.

6. The information processing apparatus according to claim 5, wherein the calculating unit calculates statistical information based on a relative distance, a relative size, or a relative angle between the reference frame and the verification frame.

7. The information processing apparatus according to claim 5, wherein the instructions further cause the at least one processor to function as:
a determining unit that determines whether or not there is incorrectness, by calculating a value indicating a degree of incorrectness in the position and size of the verification frame based on the statistical information calculated by the calculating unit, and comparing the value with a preset threshold,
wherein the display control unit displays a verification frame determined as being incorrect by the determining unit, and a corresponding image in an editable manner.

8. The information processing apparatus according to claim 7, wherein the determining unit calculates a Mahalanobis distance as a value indicating a degree of incorrectness.

9. The information processing apparatus according to claim 1, wherein the instructions further cause the at least one processor to function as:
an object detecting unit that receives input of an image, and detecting the target object in the image in order to detect the reference frame,
wherein the obtaining unit obtains the image obtained by the object detecting unit and reference frame information for the target object in the image.

10. A control method of an information processing apparatus that assists determination on correctness of information indicating a position and size of a verification segment of a target object in an image, the method comprising:
obtaining a plurality of images, reference frame information indicating positions and sizes of reference frames that enclose target objects in the images, and verification frame information indicating positions and sizes of verification frames that enclose verification segments of the target objects in the images;
normalizing a size of a reference frame indicated by the obtained reference frame information, and normalizing a size and position of a corresponding verification frame in accordance with the normalization; and
displaying a normalized reference frame at a preset position, for each of the plurality of images, and displaying, in a superimposed manner, a normalized verification frame at a relative position that is based on a normalized position and size corresponding to the normalized reference frame.

11. A non-transitory computer-readable recording medium storing a program that, when executed by a computer, causes the computer to perform a control method of an information processing apparatus that assists determination on correctness of information indicating a position and size of a verification segment of a target object in an image, the method comprising:
obtaining a plurality of images, reference frame information indicating positions and sizes of reference frames that enclose target objects in the images, and verification frame information indicating positions and sizes of verification frames that enclose verification segments of the target objects in the images;
normalizing a size of a reference frame indicated by the obtained reference frame information, and normalizing a size and position of a corresponding verification frame in accordance with the normalization; and
displaying a normalized reference frame at a preset position, for each of the plurality of images, and displaying, in a superimposed manner, a normalized verification frame at a relative position that is based on a normalized position and size corresponding to the normalized reference frame.
